(19) United States
(12) Patent Application Publication
(10) Pub. No.: US 2025/0353556 A1
(43) Pub. Date: Nov. 20, 2025

(54) VEHICLE AERODYNAMIC CONTROLLER

(71) Applicant: SUBARU CORPORATION, Tokyo (JP)

(72) Inventor: Satoshi SHIMIZU, Tokyo (JP)

(21) Appl. No.: 19/184,781

(22) Filed: Apr. 21, 2025

(30) Foreign Application Priority Data
May 14, 2024 (JP) 2024-078929

(51) Int. Cl. B62D 35/00

(52) U.S. Cl. CPC B62D 35/005; B62D 35/007

(57) ABSTRACT

A vehicle aerodynamic controller includes a ventilation adjuster, an aerodynamic unit, and a calculation processor. The ventilation adjuster is provided in a front surface of a vehicle body and configured to cover a lower portion or an entirety of a grill covering an opening provided in the front surface of the vehicle body. The aerodynamic unit is provided on the vehicle body at a different level from the ventilation adjuster and configured to be displaced between a retracted position and a deployed position. The calculation processor is configured to control operation of the ventilation adjuster and operation of the aerodynamic unit. The calculation processor is configured to allow the ventilation adjuster to cover the lower portion or the entirety of the grill, while displacing the aerodynamic unit from the retracted position toward the deployed position.

### CROSS-REFERENCE TO RELATED APPLICATIONS

The present application claims priority from Japanese Patent Application No. 2024-078929 filed on May 14, 2024, the entire contents of which are hereby incorporated by reference.

### BACKGROUND

The disclosure relates to a vehicle aerodynamic controller.

Vehicles including an active grille shutter as an aerodynamic device have emerged in recent years. An active grille shutter is configured to open and close a grille opening in accordance with an outside air temperature, etc. For example, in winter, at a start-up of an engine, closing the grille opening with the active grille shutter makes it possible to enhance efficiency of a heat exchanger. An example of an active grille shutter is described in, for example, Japanese Unexamined Patent Application Publication (JP-A) No. H06-298132.

JP-A No. 2018-95104 describes a vehicle cooling device configured to adjust an engine cooling state. In JP-A No. 2018-95104, a lower part of an engine compartment accommodating a radiator is covered with an undercover. The undercover has an opening rearward of the radiator and an opening frontward of the radiator. Moreover, a movable cover, a movable spoiler, and a link mechanism are provided. The movable cover covers the opening rearward of the radiator. The movable spoiler covers the opening frontward of the radiator. The link mechanism is provided for interlocking of the movable cover and the movable spoiler. This makes it possible to easily adjust an amount of air to be discharged from the engine compartment.

### SUMMARY

An aspect of the disclosure provides a vehicle aerodynamic controller including a ventilation adjuster, an aerodynamic unit, and a calculation processor. The ventilation adjuster is provided in a front surface of a vehicle body and configured to cover a lower portion or an entirety of a grill covering an opening provided in the front surface of the vehicle body. The aerodynamic unit is provided on the vehicle body at a different level from the ventilation adjuster and configured to be displaced between a retracted position and a deployed position. The calculation processor is configured to control operation of the ventilation adjuster and operation of the aerodynamic unit. The calculation processor is configured to allow the ventilation adjuster to cover the lower portion or the entirety of the grill, while displacing the aerodynamic unit from the retracted position toward the deployed position.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1A is a perspective view of a front part of a vehicle including a vehicle aerodynamic controller according to an embodiment of the disclosure.

FIG. 1B is a cross-sectional view of the front part of the vehicle including the vehicle aerodynamic controller according to the embodiment of the disclosure.

FIG. 2A is a cross-sectional view of flows of relative winds when an active grille shutter is in an open state, in the vehicle including the vehicle aerodynamic controller according to the embodiment of the disclosure.

FIG. 2B is a cross-sectional view of the flows of the relative winds when the active grille shutter is in a closed state, in the vehicle including the vehicle aerodynamic controller according to the embodiment of the disclosure.

FIG. 3A is a perspective view of the vehicle including the vehicle aerodynamic controller according to the embodiment of the disclosure, as viewed from bottom.

FIG. 3B is a side view of the front part of the vehicle including the vehicle aerodynamic controller according to the embodiment of the disclosure.

FIG. 4 is a block diagram of a coupling configuration of the vehicle according to the embodiment of the disclosure.

FIG. 5A is a side view of variation in contact pressure, when the active grille shutter is in the closed state, in the vehicle including the vehicle aerodynamic controller according to the embodiment of the disclosure.

FIG. 5B is a side view of the variation in the contact pressure, when movable flaps are made to protrude, in the vehicle including the vehicle aerodynamic controller according to the embodiment of the disclosure.

FIG. 6 is a side view of a movable rear mechanism disposed at a rear end of a vehicle body, in the vehicle including the vehicle aerodynamic controller according to the embodiment of the disclosure.

FIG. 7 is a graph of relation between a degree of operation of the active grille shutter and a front lift when a vehicle speed is constant, in the vehicle including the vehicle aerodynamic controller according to the embodiment of the disclosure.

FIG. 8 is a graph of relation between a degree of operation of the movable flaps and the front lift when the vehicle speed is constant, in the vehicle including the vehicle aerodynamic controller according to the embodiment of the disclosure.

FIG. 9 is a graph of changes in an aerodynamic force on the occasion that the active grille shutter is operated when the vehicle speed is constant, in the vehicle including the vehicle aerodynamic controller according to the embodiment of the disclosure.

FIG. 10 is a graph of the changes in the aerodynamic force on the occasion that the movable flaps are operated, in the vehicle including the vehicle aerodynamic controller according to the embodiment of the disclosure.

FIG. 11 is a graph of the changes in the aerodynamic force on the occasion that the active grille shutter and the movable flaps are operated, in the vehicle including the vehicle aerodynamic controller according to the embodiment of the disclosure.

FIG. 12 is a graph of the changes in the aerodynamic force on the occasion that the movable rear mechanism is operated when the vehicle speed is constant, in the vehicle including the vehicle aerodynamic controller according to the embodiment of the disclosure.

FIG. 13 is a graph of an aerodynamic window when the active grille shutter, the movable flaps, and the movable rear mechanism are operated in cooperation, in the vehicle including the vehicle aerodynamic controller according to the embodiment of the disclosure.

FIG. 14 is a graph of regions in the aerodynamic window when the active grille shutter, the movable flaps, and the movable rear mechanism are operated in cooperation, in the vehicle including the vehicle aerodynamic controller according to the embodiment of the disclosure.

### DETAILED DESCRIPTION

The techniques described in JP-A Nos. H06-298132 and 2018-95104 have still had room for improvement from the viewpoint of a lift control when an aerodynamic unit such as an active grille shutter is operated.

In one example, when the active grille shutter is in an open state, a relative wind enters the engine compartment. However, when the active grille shutter is brought to a closed state, part of the relative wind goes around below a lower surface of a vehicle body, causing an increase in contact pressure of a front tire. This causes a concern about an unnecessary change in handling when driving the vehicle.

It is desirable to provide a vehicle aerodynamic controller that makes it possible to suppress variation in contact pressure of a tire on the occasion that an aerodynamic unit such as an active grille shutter is operated.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

A vehicle aerodynamic controller 11 and a vehicle 10 according to an embodiment of the disclosure are described in detail with reference to the drawings. The following description is based on longitudinal, vertical, and horizontal directions. The horizontal direction refers to right-hand and left-hand directions when the vehicle 10 is viewed from the front.

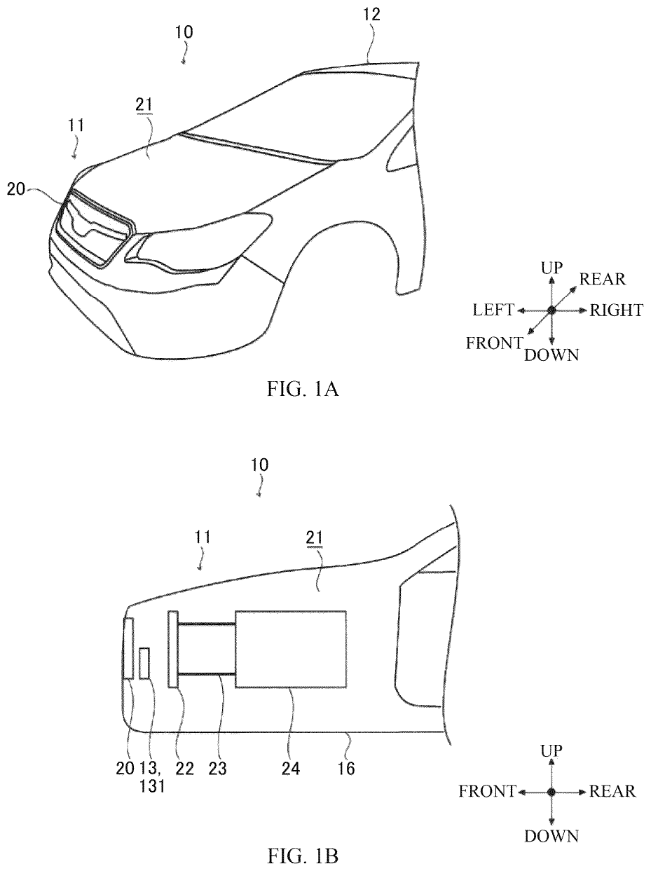

FIG. 1A is a perspective view of a front part of the vehicle 10 including the vehicle aerodynamic controller 11.

The vehicle 10 may include, for example, an engine vehicle, a BEV (Battery Electric Vehicle), an HEV (Hybrid Electric Vehicle), or a PHEV (Plug-in Hybrid Electric Vehicle), without limitation.

An engine compartment 21 is a space provided in the front part of the vehicle 10. The engine compartment 21 may accommodate, for example, an engine 24 described later.

A grille 20 is a constituent member disposed on a front surface of a vehicle body 12. The grille 20 is a substantially lattice-shaped or mesh-shaped member that covers an opening provided in the front surface of the vehicle body 12, i.e., a hood or a bumper of the vehicle body 12. As described later, when the vehicle 10 is traveling, a relative wind is introduced into the engine compartment 21 through the grille 20. A relative wind refers to an airflow that moves relative to the vehicle body in accompaniment with travel of the vehicle.

FIG. 1B is a cross-sectional view of the front part of the vehicle 10 including the vehicle aerodynamic controller 11.

In the engine compartment 21, the grille 20, a ventilation adjuster 13, a radiator 22, a pipe 23, and the engine 24 may be disposed in this order from the front.

The ventilation adjuster 13 is configured to adjust an amount of ventilation into inside the vehicle body 12, e.g., the engine compartment 21. In one example, the ventilation adjuster 13 may be a device disposed to cover a lower portion of the grille 20 and configured to adjust an air volume of the relative wind to be introduced through the grille 20.

For example, the ventilation adjuster 13 may include an active grille shutter 131. The active grille shutter 131 is configured to take an open state and a closed state based on an instruction from a calculation processor 15 described later. Bringing the active grille shutter 131 into the open state causes the relative wind to pass through the ventilation adjuster 13, and causes the relative wind to pass through an entirety of the grille 20. Bringing the active grille shutter 131 into the closed state causes the ventilation adjuster 13 to intercept the relative wind, and causes the relative wind to pass through only an upper portion of the grille 20. The active grille shutter 131 may take the open state and the closed state by a known shutter mechanism. The active grille shutter 131 is configured to change stepwise its degree of opening. The active grille shutter 131 is configured to increase its opening area to allow a large amount of the relative wind to pass through, and decrease its opening area to allow a small amount of the relative wind to pass through.

The radiator 22 is a heat exchanger coupled to the engine 24 through the pipe 23. The radiator 22, the pipe 23, and the engine 24 are configured to allow a fluid, for example, water, to flow therethrough. The fluid receives heat in the engine 24 and dissipates heat in the radiator 22. This helps to release thermal energy generated by operation of the engine 24, to the outside through the radiator 22, and cool the engine 24.

The engine 24 is an internal combustion engine to be operated using gasoline, light oil, mixed oil, hydrogen, or the like as a fuel.

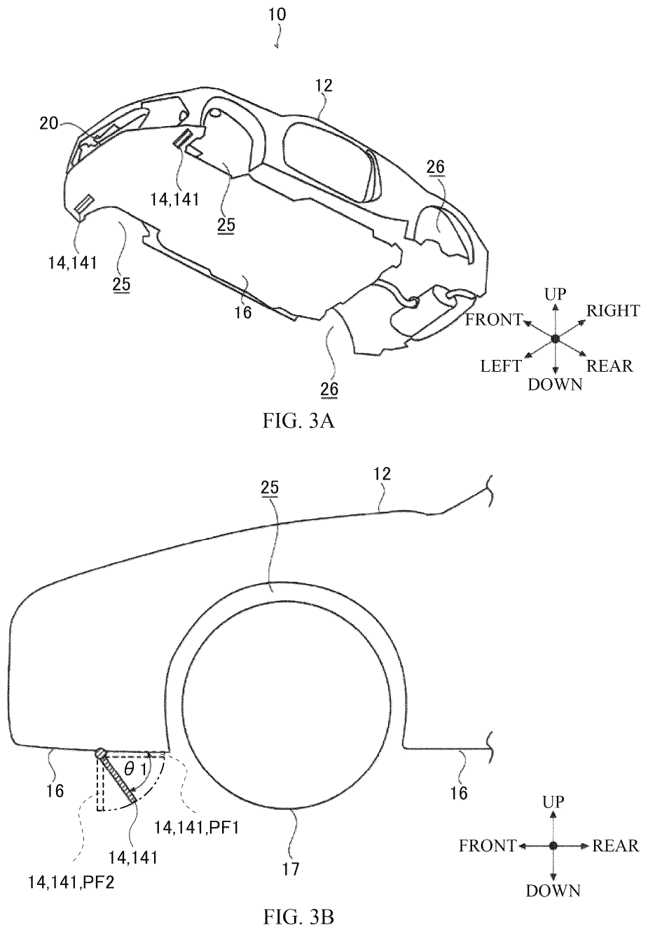

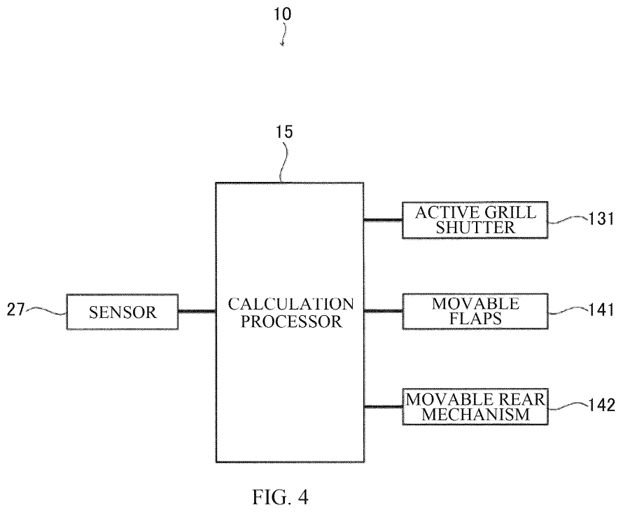

The vehicle aerodynamic controller 11 is an aerodynamic device provided in the vehicle 10. The vehicle aerodynamic controller 11 may include, for example, the ventilation adjuster 13, an aerodynamic unit 14, and the calculation processor 15. The ventilation adjuster 13 may include the active grille shutter 131. The aerodynamic unit 14 may include movable flaps 141. The aerodynamic unit 14 is described later with reference to, for example, FIG. 3B. The calculation processor 15 is described later with reference to, for example, FIG. 4.

In this embodiment, allowing the active grille shutter 131 and the movable flaps 141 to be operated in cooperation makes it possible to keep contact pressure of a front tire 17 substantially constant. Moreover, combining a movable rear mechanism 142 described later with the active grille shutter 131 and the movable flaps 141, and allowing them to be operated in cooperation make it possible to make variable absolute values of lifts of the front part and a rear part of the vehicle 10, and further, make variable a balance between the lifts acting on the front part and the rear part of the vehicle 10.

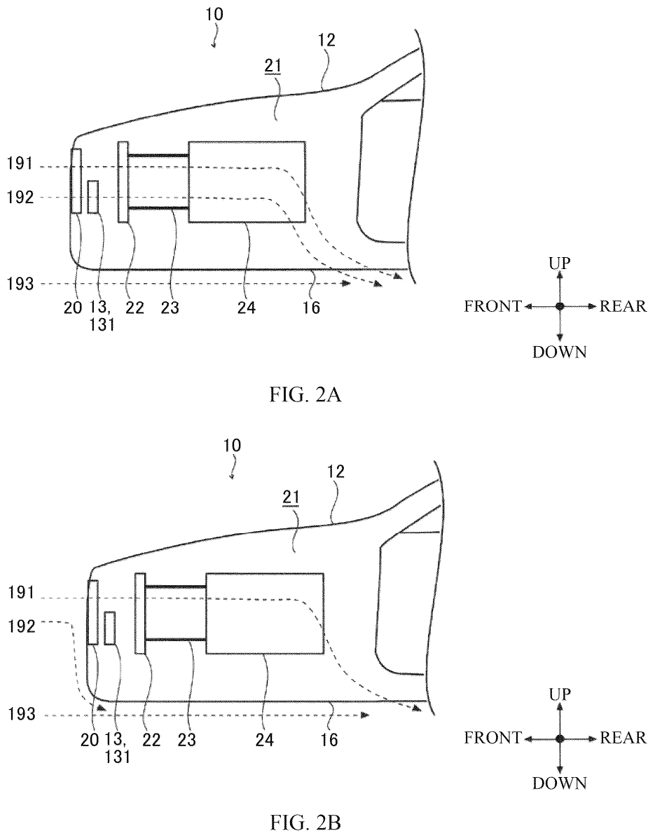

FIG. 2A is a cross-sectional view of flows of the relative winds when the active grille shutter 131 is in the open state.

As the vehicle 10 travels, relative winds 191, 192, and 193 are generated. The relative winds 191 to 193 are airflows that move rearward relative to the vehicle 10.

The relative wind 191 is blown toward the upper portion of the grille 20. No ventilation adjuster 13 is provided rearward of the upper portion of the grille 20. Accordingly, the relative wind 191 passes through the upper portion of the grille 20, receives heat by being blown to the radiator 22, and afterwards, passes from a lower rear portion of the engine compartment 21 to under a lower surface 16 of the vehicle body.

The relative wind 192 is blown toward the lower portion of the grille 20. The ventilation adjuster 13 disposed rearward of the lower portion of the grille 20 is in the open state and is able to let the wind pass through. Accordingly, the relative wind 192 passes through the lower portion of the grille 20 and the ventilation adjuster 13, receives heat by being blown to the radiator 22, and afterwards, passes from the lower rear portion of the engine compartment 21 to under the lower surface 16 of the vehicle body.

The relative wind 193 is an airflow passing through between the lower surface 16 of the vehicle body and the unillustrated ground.

FIG. 2B is a cross-sectional view of the flows of the relative winds when the active grille shutter 131 is in the closed state.

The relative wind 191 and the relative wind 193 are similar to the case in FIG. 2A.

Entry of the relative wind 192 into the engine compartment 21 is intercepted by the active grille shutter 131 in the closed state. Accordingly, the relative wind 192 travels downward along the front surface of the vehicle body 12, and afterwards, flows rearward under the lower surface 16 of the vehicle body.

As illustrated in FIGS. 2A and 2B, a route of the relative wind 192 differs depending on the state of the active grille shutter 131. This causes variation in the lift acting on the vehicle body 12. However, in the embodiment, operating the aerodynamic unit 14 described later makes it possible to suppress the variation.

FIG. 3A is a perspective view of the vehicle 10 including the vehicle aerodynamic controller 11, as viewed from bottom. The vehicle body 12 may include front tire houses 25 and rear tire houses 26. In each of the front tire houses 25, the front tire 17 described later may be disposed. In each of the rear tire houses 26, a rear tire 18 described later may be disposed.

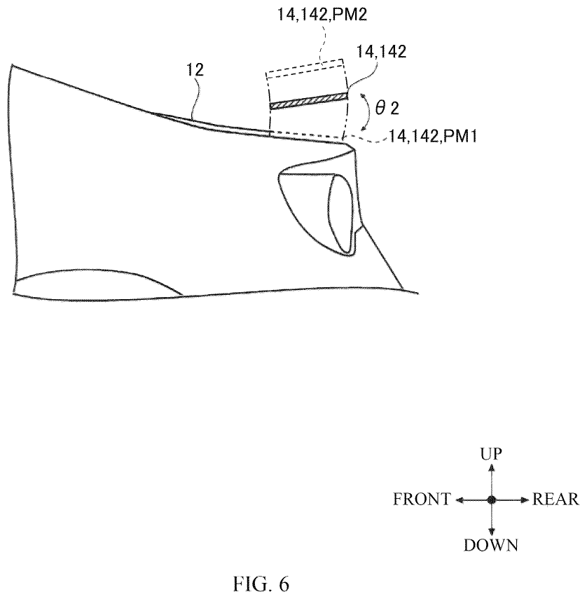

The aerodynamic unit 14 may include a device configured to be displaced to change an aerodynamic effect. The aerodynamic unit 14 may include the movable flaps 141. The movable flaps 141 may be disposed frontward of the front tire houses 25 on the lower surface 16 of the vehicle body. The movable flaps 141 may be disposed in corresponding relation to the front tire houses 25 on both sides. As described later, the aerodynamic unit 14 may additionally include the movable rear mechanism 142, e.g., a rear wing, illustrated in FIG. 6.

FIG. 3B is a side view of the front part of the vehicle 10 including the vehicle aerodynamic controller 11.

The movable flaps 141 may be attached to the lower surface 16 of the vehicle body, frontward of the front tires 17. Each of the movable flaps 141 may include a substantially plate-shaped member, and include a front end turnably coupled to the lower surface 16 of the vehicle body. Turning operation of the movable flaps 141 may be performed by an unillustrated actuator such as a motor.

When the vehicle 10 is viewed from sideward, an angle formed by the movable flaps 141 and the lower surface 16 of the vehicle body is assumed as θ1. When the angle θ1 is 0 degrees (retracted position), that is, when largest surfaces of the movable flaps 141 are in close contact with the lower surface 16 of the vehicle body, no aerodynamic effect of the movable flaps 141 is generated, and the lift generated in a front portion of the vehicle body 12 becomes smaller. When the angle θ1 is a maximum angle, e.g., 90 degrees (deployed position), that is, when the largest surfaces of the movable flaps 141 protrude from the lower surface 16 of the vehicle body, the aerodynamic effect of the movable flaps 141 is generated, and the lift generated in the front portion of the vehicle body 12 becomes larger.

FIG. 4 is a block diagram of a coupling configuration of the vehicle 10.

The vehicle 10 may include the calculation processor 15, a sensor 27, the active grille shutter 131, the movable flaps 141, and the movable rear mechanism 142.

The calculation processor 15 may include, for example, a semiconductor element such as a CPU (Central processing unit). The calculation processor 15 may further include, as a storage, a semiconductor memory device such as a RAM (Random Access Memory) or a ROM (Read only memory). Such a storage may hold programs, parameters, etc. The calculation processor 15 may perform processing described later based on the programs, the parameters, etc. read out from the storage. The calculation processor 15 is configured to control operation of the ventilation adjuster 13 and operation of the aerodynamic unit 14 described above. As described later, the calculation processor 15 is configured to change the amount of ventilation by the ventilation adjuster 13 while displacing the aerodynamic unit 14 to increase the aerodynamic effect. When the opening area of the active grille shutter 131 becomes larger, the lift acting on the front portion of the vehicle body 12 becomes smaller, and thus, the calculation processor 15 may decrease an angle at which the movable flaps 141 protrude.

The sensor 27 may be coupled to an input-side terminal of the calculation processor 15. The sensor 27 may be provided in the vehicle body 12. The sensor 27 may measure, for example, an outside air temperature, a travel speed, etc. and transmit data indicating them to the calculation processor 15.

To an output-side terminal of the calculation processor 15, the active grille shutter 131, the movable flaps 141, and the movable rear mechanism 142 (see FIG. 6) may be coupled. In one example, the calculation processor 15 may change the state of the active grille shutter 131 in FIG. 2A to the open state or the closed state. Moreover, the calculation processor 15 may adjust the angle θ1 of the movable flaps 141, between the retracted position and the deployed position. Furthermore, the calculation processor 15 may change an angle θ2 of the movable rear mechanism 142 described later, similarly between a retracted position and a deployed position.

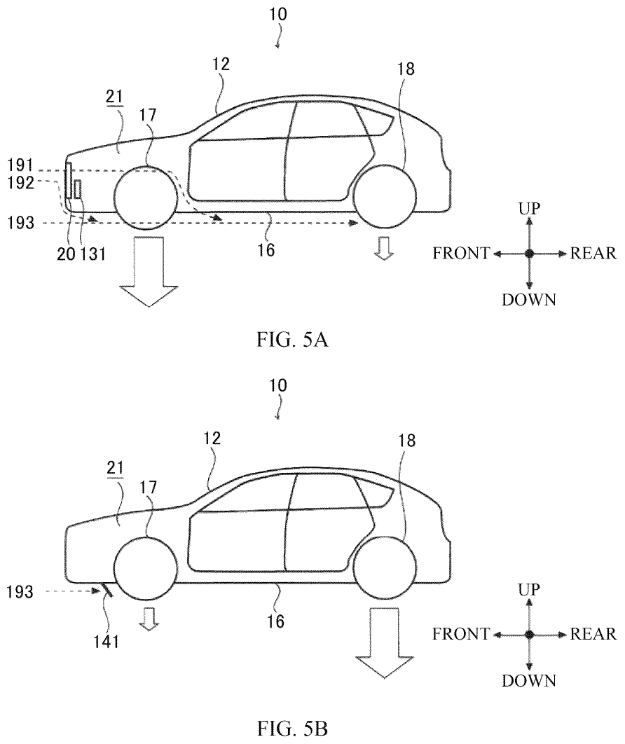

Referring to FIGS. 5A and 5B, magnitude of the lift while the vehicle is traveling is described.

FIG. 5A is a side view of variation in the contact pressure, when the active grille shutter 131 is in the closed state. When the active grille shutter 131 is operated and brought to the closed state in accordance with the instruction from the calculation processor 15 described above, the relative wind 192 does not enter the engine compartment 21 but goes around below the lower surface 16 of the vehicle body. Thus, the lift acting on the front portion of the vehicle body 12 becomes smaller.

FIG. 5B is a side view of the variation in the contact pressure, when the movable flaps 141 are made to protrude toward the deployed position. The calculation processor 15 may operate the active grille shutter 131 to the closed state, and make the movable flaps 141 protrude from the lower surface 16 of the vehicle body. In other words, the calculation processor 15 may increase the angle θ1 illustrated in FIG. 3B to, for example, about 90 degrees. When the movable flaps 141 are made to protrude toward the deployed position, an opposite effect to a case where the active grille shutter 131 is brought to the closed state is generated with respect to the generation of the lift.

In this way, it is possible to suppress the variation in the contact pressure of the front tires 17. In one example, as for the front tires 17, bringing the active grille shutter 131 to the closed state causes a decrease in the lift and an increase in the contact pressure. However, making the movable flaps 141 protrude toward the deployed position causes an increase in the lift, making the contact pressure substantially constant. Moreover, by adopting the movable flaps 141 and the movable rear mechanism 142 described later as the aerodynamic unit 14, it is possible to make variable both the absolute values of the lifts and the longitudinal balance between the lifts, as described later with reference to FIG. 6 and the like.

FIG. 6 is a side view of the movable rear mechanism 142 disposed at a rear end of the vehicle body 12.

The movable rear mechanism 142 serves as an example of the aerodynamic unit 14 described above. As described above, in one example, the aerodynamic unit 14 may include, for example, the movable flaps 141. In another example, the aerodynamic unit 14 may include both the movable flaps 141 and the movable rear mechanism 142. Thus, it is possible to make variable the absolute values of the lifts and the longitudinal balance between the lifts, as described later.

The movable rear mechanism 142 may be an elongated member longitudinally aligned with a vehicle widthwise direction. The movable rear mechanism 142 may include a substantially plate-shaped member having a largest surface directed in the vertical direction. The movable rear mechanism 142 may be disposed on an upper surface of the vehicle body 12 at the rear end of the vehicle or the vehicle body.

In the movable rear mechanism 142, an unillustrated actuator may change the aerodynamic effect of the movable rear mechanism 142 based on the instruction from the calculation processor 15 described above. For example, the unillustrated actuator may change a height, the angle θ2, a longitudinal position, etc. of the movable rear mechanism 142. Furthermore, the movable rear mechanism 142 may include a wing-shaped one or a spoiler-shaped one.

A degree of opening of the movable rear mechanism 142 may be interlinked with the active grille shutter 131 and the movable flaps 141 described above. In this way, it is possible to adjust the absolute values of the lifts in the front and rear parts of the vehicle 10, and the balance between the lifts.

The movable rear mechanism 142 is configured to change the degree of opening, i.e., a degree of operation, from 0% to 100%. Referring to FIG. 6, the movable rear mechanism 142 having the degree of opening of 0% (retracted position) is substantially in close contact with the upper surface of the vehicle body 12. The movable rear mechanism 142 with the degree of opening of 100% (deployed position) has the maximum angle θ2 of, for example, 40 degrees. The lift to be generated by the movable rear mechanism 142 is negatively correlated with the degree of opening of the movable rear mechanism 142. That is, as the degree of opening of the movable rear mechanism 142 becomes higher, the lift becomes smaller.

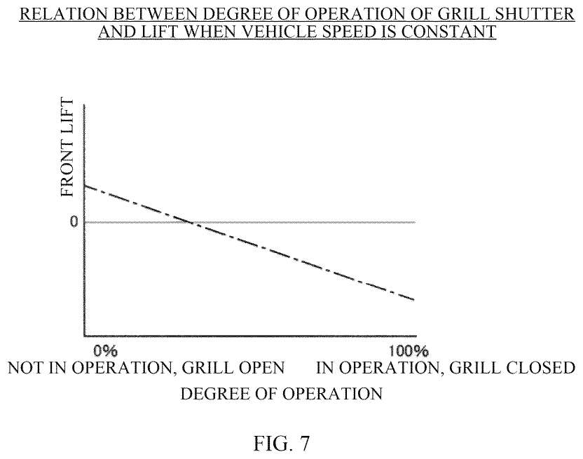

FIG. 7 is a graph of relation between a degree of opening of the active grille shutter 131 and the lift, when the vehicle speed of the vehicle 10 is constant. In the graph in FIG. 7, the horizontal axis indicates the degree of opening, i.e., a degree of operation, of the active grille shutter 131. The vertical axis indicates magnitude of the lift to be generated.

The active grille shutter 131 is configured to change the degree of operation from 0% to 100%. The active grille shutter 131 with the degree of operation of 0% is configured to let the relative wind 192 described above pass through. The active grille shutter 131 with the degree of operation of 100% is configured to intercept the relative wind 192 described above. The lift to be generated by the active grille shutter 131 is negatively correlated with the degree of operation of the active grille shutter 131. That is, as the degree of operation of the active grille shutter 131 becomes higher, the lift becomes smaller.

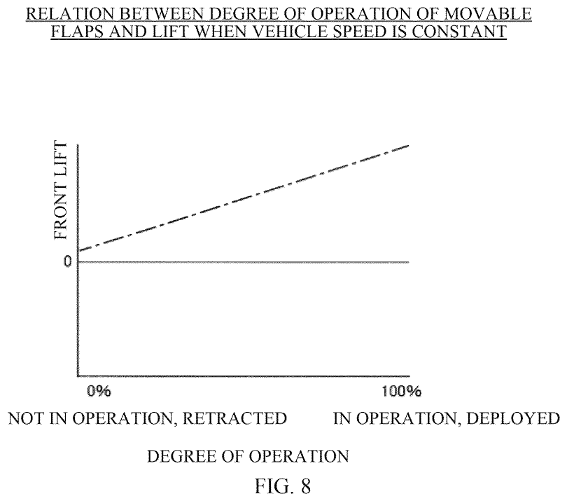

FIG. 8 is a graph of relation between a degree of operation of the movable flaps 141 and the lift, when the vehicle speed of the vehicle 10 is constant. In the graph in FIG. 8, the horizontal axis indicates a degree of opening, i.e., the degree of operation, of the movable flaps 141. The vertical axis indicates magnitude of the lift to be generated. The degree of operation of the movable flaps 141 indicates magnitude of the angle θ1 at which the movable flaps 141 illustrated in FIG. 3B are inclined.

The movable flaps 141 are configured to change the degree of operation from 0% to 100%. Referring to FIG. 3B, the movable flaps 141 with the degree of operation of 0% are in close contact with the lower surface 16 of the vehicle body. The movable flaps 141 with the degree of operation of 100% have the maximum angle θ1 of, for example, 90 degrees. The lift to be generated by the movable flaps 141 is positively correlated with the degree of operation of the movable flaps 141. That is, as the degree of operation of the movable flaps 141 becomes higher, the lift acting on the front side of the vehicle 10 becomes larger.

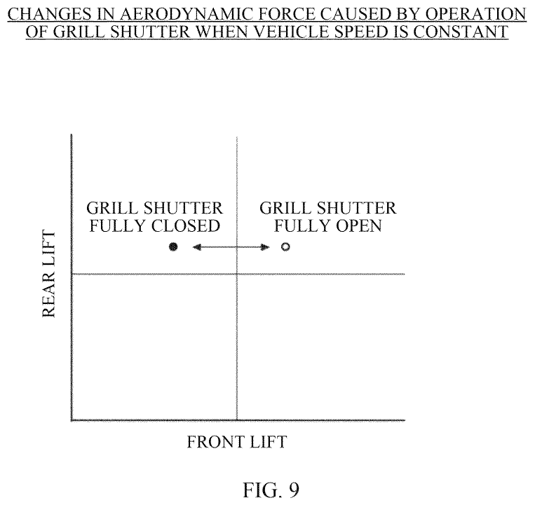

FIG. 9 is a graph of changes in an aerodynamic force on the occasion that the active grille shutter 131 is operated when the vehicle speed is constant. In this graph, the horizontal axis represents the lift acting on the front part of the vehicle 10, and the vertical axis represents the lift acting on the rear part of the vehicle 10.

For example, when the active grille shutter 131 is brought to a fully open state from a fully closed state, the lift acting on the front part of the vehicle 10 becomes larger. In contrast, when the active grille shutter 131 is brought to the fully closed state from the fully open state, the lift acting on the front part of the vehicle 10 becomes smaller. The lift acting on the rear part of the vehicle 10 does not change, whether the active grille shutter 131 is opened or closed.

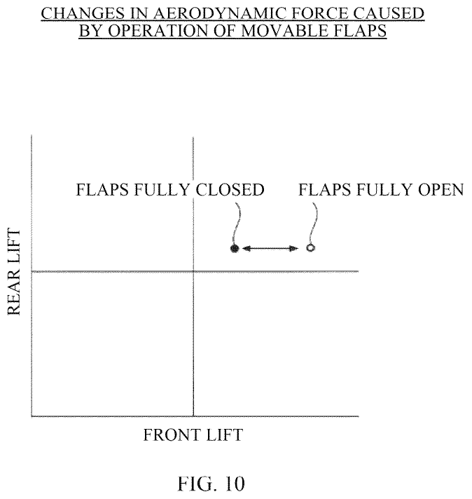

FIG. 10 is a graph of the changes in the aerodynamic force on the occasion that the degree of operation of the movable flaps 141 is changed. In this graph, the horizontal axis represents the lift acting on the front part of the vehicle 10, and the vertical axis represents the lift acting on the rear part of the vehicle 10.

When the degree of operation of the movable flaps 141 is changed to the fully open state from the fully closed state, the lift acting on the front part of the vehicle 10 becomes larger. In contrast, when the movable flaps 141 are brought to the fully closed state from the fully open state, the lift acting on the front part of the vehicle 10 becomes smaller. The lift acting on the rear part of the vehicle 10 basically does not change, whether the movable flaps 141 are opened or closed.

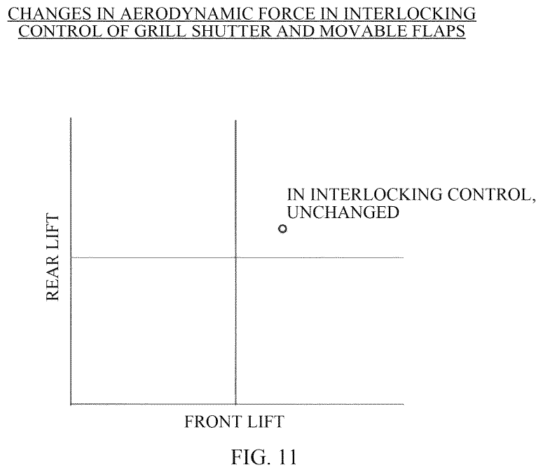

FIG. 11 is a graph of the changes in the aerodynamic force on the occasion that the active grille shutter 131 and the movable flaps 141 are operated. In this graph, the horizontal axis represents the lift acting on the front part of the vehicle 10, and the vertical axis represents the lift acting on the rear part of the vehicle 10.

In this embodiment, the active grille shutter 131 and the movable flaps 141 are interlinked to make constant the lift acting on the front part of the vehicle 10. Moreover, even when the degrees of operation of the active grille shutter 131 and the movable flaps 141 are changed, the lift acting on the rear part of the vehicle 10 basically does not change.

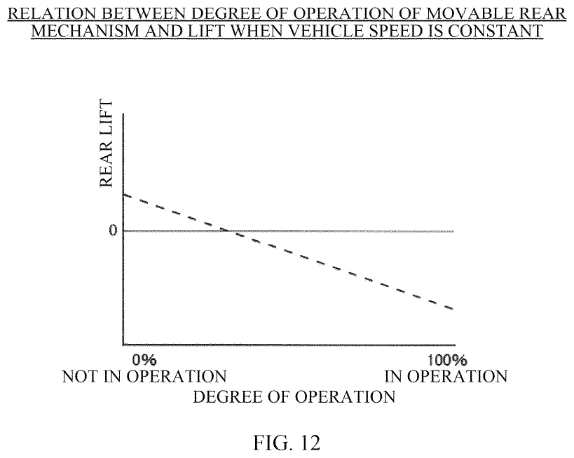

FIG. 12 is a graph of changes in the lift acting on the rear part of the vehicle 10 on the occasion that the movable rear mechanism 142 is operated when the vehicle speed is constant. In this graph, the horizontal axis represents the degree of operation of the movable rear mechanism 142, and the vertical axis represents the lift acting on the rear part of the vehicle 10.

As is clear from FIG. 12, the degree of operation of the movable rear mechanism 142 and the lift acting on the rear part of the vehicle 10 have negative correlation. That is, as the degree of operation of the movable rear mechanism 142 becomes larger, for example, as the angle θ2 of the movable rear mechanism 142 illustrated in FIG. 6 becomes larger, the lift acting on the rear part of the vehicle 10 becomes smaller.

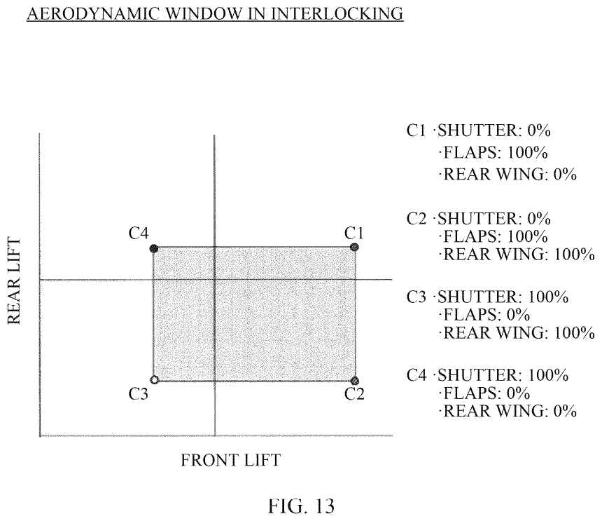

FIG. 13 is a graph of an aerodynamic window when the active grille shutter 131, the movable flaps 141, and the movable rear mechanism 142, i.e., the rear wing, are operated in cooperation. In this graph, the horizontal axis represents the lift acting on the front part of the vehicle 10, and the vertical axis represents the lift acting on the rear part of the vehicle 10. The aerodynamic window is a region in which any aerodynamic value is obtained by operating the active grille shutter 131, the movable flaps 141, and the movable rear mechanism 142. In this graph, the aerodynamic window is hatched.

The upper right corner of the aerodynamic window is indicated by a condition C1. The lower right corner is indicated by a condition C2. The lower left corner is indicated by a condition C3. The upper left corner is indicated by a condition C4.

Under the condition C1, the degree of operation of the active grille shutter 131 is 0%, the degree of operation of the movable flaps 141 is 100%, and the degree of operation of the movable rear mechanism 142 is 0%. In this case, the lift acting on the front part of the vehicle 10 is maximum, and the lift acting on the rear part of the vehicle 10 is maximum.

Under the condition C2, the degree of operation of the active grille shutter 131 is 0%, the degree of operation of the movable flaps 141 is 100%, and the degree of operation of the movable rear mechanism 142 is 100%. In this case, the lift acting on the front part of the vehicle 10 is maximum, and the lift acting on the rear part of the vehicle 10 is minimum.

Under the condition C3, the degree of operation of the active grille shutter 131 is 100%, the degree of operation of the movable flaps 141 is 0%, and the degree of operation of the movable rear mechanism 142 is 100%. In this case, the lift acting on the front part of the vehicle 10 is minimum, and the lift acting on the rear part of the vehicle 10 is minimum.

Under the condition C4, the degree of operation of the active grille shutter 131 is 100%, the degree of operation of the movable flaps 141 is 0%, and the degree of operation of the movable rear mechanism 142 is 0%. In this case, the lift acting on the front part of the vehicle 10 is minimum, and the lift acting on the rear part of the vehicle 10 is maximum.

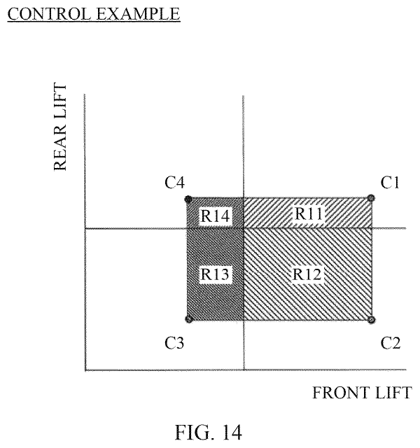

FIG. 14 is a graph of regions in the aerodynamic window when the active grille shutter 131, the movable flaps 141, and the movable rear mechanism 142 are operated in cooperation. The aerodynamic window is hatched. Furthermore, the regions to be subjected to different controls in the aerodynamic window are differently hatched.

The aerodynamic window in FIG. 14 includes a region R11, a region R12, a region R13, and a region R14. As described below, the calculation processor 15 is configured to change the degrees of operation of the active grille shutter 131, the movable flaps 141, and the movable rear mechanism 142 based on a travel state of the vehicle 10. The calculation processor 15 may determine the travel state based on data inputted from an accelerator and brakes of the vehicle 10, a steering angle sensor, an ABS (Anti-lock Brake System) sensor, a G sensor, a sensor configured to detect a vehicle height, and a camera configured to monitor a frontward view of the vehicle.

The region R11 is a region in which the degree of operation of the movable flaps 141 is made higher than the degrees of operation of the active grille shutter 131 and the movable rear mechanism 142 based on the instruction from the calculation processor 15. This makes it possible to enhance travel performance of the vehicle 10 in a normal travel state.

The region R12 is a region in which the degrees of operation of the movable flaps 141 and the movable rear mechanism 142 are made higher than the degree of operation of the active grille shutter 131 based on the instruction from the calculation processor 15. This makes it possible to enhance the travel performance of the vehicle 10 in acceleration while the vehicle is traveling, and in cornering on a travel road having a low friction coefficient.

The region R13 is a region in which the degrees of operation of the active grille shutter 131 and the movable rear mechanism 142 are made higher than the degree of operation of the movable flaps 141 based on the instruction from the calculation processor 15. This makes it possible to enhance the travel performance of the vehicle 10 in braking, and on straight travel.

The region R14 is a region in which the degree of operation of the active grille shutter 131 is made higher than the degrees of operation of the movable flaps 141 and the movable rear mechanism 142 based on the instruction from the calculation processor 15. This makes it possible to enhance the travel performance of the vehicle 10 in emergency braking and in sudden cornering.

In the following, the technical idea to be grasped from the forgoing embodiment is described together with effects thereof.

A vehicle aerodynamic controller according to the embodiment of the disclosure includes a ventilation adjuster, an aerodynamic unit, and a calculation processor. The ventilation adjuster is configured to adjust the amount of ventilation into inside a vehicle body. The aerodynamic unit is configured to be displaced to change an aerodynamic effect. The calculation processor is configured to control the operation of the ventilation adjuster and the operation of the aerodynamic unit. The calculation processor is configured to change the amount of ventilation by the ventilation adjuster while displacing the aerodynamic unit to increase the aerodynamic effect. According to the vehicle aerodynamic controller of the embodiment of the disclosure, increasing the amount of ventilation and increasing the aerodynamic effect make it possible to appropriately maintain a load balance in the vehicle, and bring the contact pressure of each tire to a predetermined value. Hence, it is possible to ensure handling performance.

Moreover, in the vehicle aerodynamic controller according to the embodiment of the disclosure, the ventilation adjuster may include an active grille shutter. The aerodynamic unit may include a movable flap attached to a lower surface of the vehicle body. The calculation processor is configured to, when the active grille shutter is brought to a closed state, increase an angle at which the movable flap protrudes. According to the vehicle aerodynamic controller of the embodiment of the disclosure, when the active grille shutter is brought to the closed state, causing a decrease in a lift in a front part of the vehicle, the lift is increased by increasing the angle at which the movable flap protrudes. Hence, it is possible to make the lift substantially constant, and suppress variation in contact pressure of tires disposed on the front side of the vehicle.

Furthermore, in the vehicle aerodynamic controller according to an embodiment of the disclosure, the movable flap may include a substantially plate-shaped member including a front end turnably coupled to the lower surface of the vehicle body. According to the vehicle aerodynamic controller of the embodiment of the disclosure, the movable flap has the substantially plate shape. Accordingly, making the movable flap protrude makes it possible to generate the lift effectively.

In addition, in the vehicle aerodynamic controller according to the embodiment of the disclosure, the vehicle body includes a front tire house, and the movable flap is disposed frontward of the front tire house. According to the vehicle aerodynamic controller of the embodiment of the disclosure, it is possible to produce a remarkable effect of generating the lift effectively.

Moreover, in the vehicle aerodynamic controller according to the embodiment of the disclosure, the aerodynamic unit may further include a movable rear mechanism. According to the vehicle aerodynamic controller of the embodiment of the disclosure, it is possible to increase the contact pressure of rear tires by the movable rear mechanism, leading to further enhancement of the handling performance.

Furthermore, in the vehicle aerodynamic controller according to the embodiment of the disclosure, the calculation processor may make a degree of operation of the movable flap higher than degrees of operation of the active grille shutter and the movable rear mechanism. According to the vehicle aerodynamic controller of the embodiment of the disclosure, it is possible to enhance the travel performance of the vehicle in a normal travel state.

In addition, in the vehicle aerodynamic controller according to the embodiment of the disclosure, the calculation processor may make the degrees of operation of the movable flap and the movable rear mechanism higher than the degree of operation of the active grille shutter. According to the vehicle aerodynamic controller of the embodiment of the disclosure, it is possible to enhance the travel performance of the vehicle in acceleration while the vehicle is traveling, and in cornering on a travel road having a low friction coefficient.

Moreover, in the vehicle aerodynamic controller according to the embodiment of the disclosure, the calculation processor may make the degrees of operation of the active grille shutter and the movable rear mechanism higher than the degree of operation of the movable flap. According to the vehicle aerodynamic controller of the embodiment of the disclosure, it is possible to enhance the travel performance of the vehicle in braking, and on the straight travel.

Furthermore, in the vehicle aerodynamic controller according to the embodiment of the disclosure, the calculation processor may make the degree of operation of the active grille shutter higher than the degrees of operation of the movable flap and the movable rear mechanism. According to the vehicle aerodynamic controller of the embodiment of the disclosure, it is possible to enhance the travel performance of the vehicle in emergency braking, and in sudden cornering.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof. Moreover, the forgoing embodiments may be combined with one another.

For example, referring to FIG. 1B, in the forgoing embodiment, the active grille shutter 131 is configured to cover the lower portion of the grille 20 from the rear. However, such a configuration may be changed. In one example, the active grille shutter 131 may be configured to cover the entirety of the grille 20 from the rear.

The calculation processor 15 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the calculation processor 15. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the calculation processor 15 illustrated in FIG. 1.

1. A vehicle aerodynamic controller comprising:
a ventilation adjuster provided in a front surface of a vehicle body and configured to cover a lower portion or an entirety of a grill covering an opening provided in the front surface of the vehicle body;
an aerodynamic unit provided on the vehicle body at a different level from the ventilation adjuster and configured to be displaced between a retracted position and a deployed position; and
a calculation processor configured to control operation of the ventilation adjuster and operation of the aerodynamic unit,
the calculation processor being configured to allow the ventilation adjuster to cover the lower portion or the entirety of the grill, while displacing the aerodynamic unit from the retracted position toward the deployed position.

2. The vehicle aerodynamic controller according to claim 1, wherein
the ventilation adjuster is configured to be displaced between an open state in which the ventilation adjuster opens the lower portion or the entirety of the grill, and a closed state in which the ventilation adjuster covers the lower portion or the entirety of the grill,
the aerodynamic unit comprises a movable flap attached to a lower surface of the vehicle body, and
the calculation processor is configured to, when the active grill shutter is brought to a closed state, increase an angle at which the movable flap protrudes from the lower surface of the vehicle body.

3. The vehicle aerodynamic controller according to claim 2, wherein
the movable flap comprises a substantially plate-shaped member including a front end turnably coupled to the lower surface of the vehicle body.

4. The vehicle aerodynamic controller according to claim 2, wherein
the vehicle body includes a front tire house,
the front tire house includes a front tire, and
the movable flap is disposed frontward of the front tire.

5. The vehicle aerodynamic controller according to claim 3, wherein
the vehicle body includes a front tire house,
the front tire house includes a front tire, and
the movable flap is disposed frontward of the front tire.

6. The vehicle aerodynamic controller according to claim 1, wherein
the ventilation adjuster comprises an active grill shutter, and
the aerodynamic unit comprises a movable flap attached to a lower surface of the vehicle body, and a movable rear mechanism disposed on an upper surface of the vehicle body at a rear end of the vehicle body.

7. The vehicle aerodynamic controller according to claim 6, wherein
the calculation processor is configured to make a degree of operation of the movable flap higher than degrees of operation of the active grill shutter and the movable rear mechanism.

8. The vehicle aerodynamic controller according to claim 6, wherein
the calculation processor is configured to make degrees of operation of the movable flap and the movable rear mechanism higher than a degree of operation of the active grill shutter.

9. The vehicle aerodynamic controller according to claim 6, wherein
the calculation processor is configured to make degrees of operation of the active grill shutter and the rear mechanism higher than a degree of operation of the movable flap.

10. The vehicle aerodynamic controller according to claim 6, wherein
the calculation processor is configured to make a degree of operation of the active grill shutter higher than degrees of operation of the movable flap and the movable rear mechanism.
